(19) United States
(12) Patent Application Publication
(10) Pub. No.: US 2004/0135435 A1
(43) Pub. Date: Jul. 15, 2004

(54) System and method for preventing unauthorized bypass of an OEM security system

(75) Inventor: Robert A. Nelson, Hampstead (CA)

Correspondence Address: MERCHANT & GOULD PC, P.O. BOX 2903, MINNEAPOLIS, MN, 55402-0903, US

(73) Assignee: Automobility Distribution Inc., Ville St-Laurent (CA)

(21) Appl. No.: 10/614,730

(22) Filed: Jul. 7, 2003

(30) Foreign Application Priority Data
Jul. 5, 2002 (CA) 2,392,635

(51) Int. Cl. B60R 25/04

(52) U.S. Cl. 307/10.3; 340/5.64; 340/426.1

(57) ABSTRACT

A system for preventing the unauthorized by-pass of an OEM security system is disclosed. The system includes an OEM starter for starting a vehicle; an OEM security system in communication with said starter; a by-pass kit for by-passing said OEM security system and enabling remote car starting of the vehicle without placing the key in the ignition; a remote car starter device in communication with the by-pass kit for sending a signal to the by-pass kit to start the engine; and a remote car starter transmitter in wireless communication with the remote car starter device. The signal that is sent to said by-pass kit is data, so that the by-pass kit is adapted to by-pass the OEM security system only upon receipt of the data signal. The improvement can be brought to both transponder-based bypass kits and microprocessor-based bypass kits.

### FIELD OF THE INVENTION

The present invention relates to a system and method for preventing the unauthorized bypass of an OEM vehicle security system, or engine, or starter disable when a remote car starter is installed (either at the factory or aftermarket).

### DESCRIPTION OF THE PRIOR ART

Remote car starters are well known in the art and generally comprise an RF transmitter borne by a person and a device in a vehicle, which upon receipt of an appropriate signal emitted from the transmitter, allows the starter module to begin to start the vehicle.

Many vehicles are provided with original equipment manufacturer (OEM) security systems, starter disable systems or engine disable systems. These will be generically referred to in the present description as “OEM security systems”. In order for remote car starter to function properly, they must be provided with by-pass kits to by-pass the OEM security systems. Such by-pass kits are well known in the art, and are commercialized under vehicle-specific or generic kits.

The by-pass kits are of two varieties. The first one is transponder-based. When a signal is received from the remote starter, the transponder sends a signal to the barrel of the ignition to start the engine. The second one is microprocessor-based, and upon receipt of a signal from the remote starter, the microprocessor sends a signal to the OEM security system to start the car. In fact, the signal that is send is essentially grounding one of the wires.

These by-pass kits can be circumvented by thieves to steal the vehicle. In the case of the microprocessor-based by-pass, this is done by applying a ground signal to the by-pass kit imitating the signal from the remote starter, and in the case of the transponder-based by-pass, by actually physically placing the by-pass transponder near the steering column of the vehicle and breaking the ignition.

### SUMMARY OF THE INVENTION

It is an object of the present invention to provide a system and method for preventing an unauthorized bypass of a OEM security system.

In accordance with one aspect of the invention there is provided a system for preventing the unauthorized by-pass of an OEM security system comprising:

an OEM starter for starting a vehicle;

an OEM security system in communication with said starter;

a by-pass kit for by-passing said OEM security system and enabling remote car starting of said vehicle without placing said key in said ignition;

a remote car starter device in communication with said by-pass kit for sending a signal to said by-pass kit to start said engine; and

a remote car starter transmitter in wireless communication with said remote car starter device;

wherein said signal is data that is sent to said by-pass kit is data, and wherein said by-pass kit is adapted to by-pass said OEM security system only upon receipt of said signal.

Generally, the invention consists in modifying a conventional by-pass kit so that it by-passes the OEM security system only upon receipt and/or transmission of specific data. Simply applying a ground to the by-pass kit will not bypass the OEM security system or in the case of the transponder by-pass, encasing the transponder in a metal box (through which the signal cannot go through), so that the OEM security system is by-passed only upon receipt and/or transmission of specific data. Alternatively, a transmitter is installed in the car which transmits constantly to the OEM security system to keep it busy so that even if the proper key is received, as will be explained hereinafter

### BRIEF DESCRIPTION OF THE DRAWINGS

The present invention and its advantages will be more easily understood after reading the following non-restrictive description of preferred embodiments thereof, made with reference to the following drawings in which:

FIG. 1 is a schematic representation of the system according to a preferred embodiment of the invention;

FIG. 2 is a schematic representation of the system according to another preferred embodiment of the invention; and

FIG. 3 is a schematic representation of the system according to yet another preferred embodiment of the invention.

### DESCRIPTION OF PREFERRED EMBODIMENTS OF THE INVENTION

The present invention concerns a system and method for preventing unauthorized bypass of a remote car starter 15. Vehicles are nowadays equipped with an OEM security system 12, in communication with an OEM starter 11. When a vehicle is equipped with a remote car starter 15, a by-pass kit 13, 13′ must be provided to enable remote starting of the vehicle. The present invention concerns improvements to such by-pass kits 13, 13′ to increase security and to decrease the risk of theft of the vehicle.

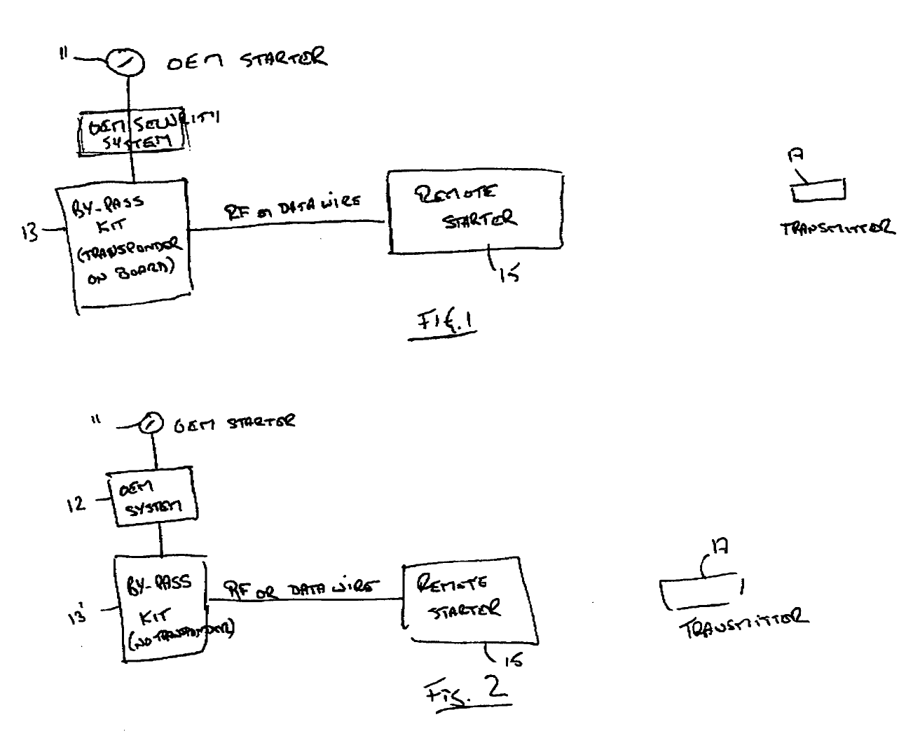

FIG. 1 is a schematic representation of the system according to a first preferred embodiment of the invention. This Figure shows a factory alarm bypass (transponder on board) 13, showing the interconnection of the bypass 13 with the remote starter 15. This interconnection can be through a data wire or cable, or RF, where the information that is transmitted is data. The communication although preferably unidirectional can also be bi-directional in order to increase the degree of security. The factory alarm bypass is encased in metal. The purpose of encasing the factory alarm bypass in metal is to prevent the transponder signal from exiting the bypass. If the bypass were not encased in metal, thieves would still be able to locate the bypass, physically approach the steering column with it and start the engine, since the receiver aboard the vehicle would still read the correct signal. Hence, the bypass is encased in metal, and the bypass will be activated only if the correct data is sent. Thus, when activating transmitter 17 to remotely start the car, the remote starter sends the correct signal to the by-pass kit and the by-pass kit sends a signal to the OEM security system, thereby enabling starting of the vehicle.

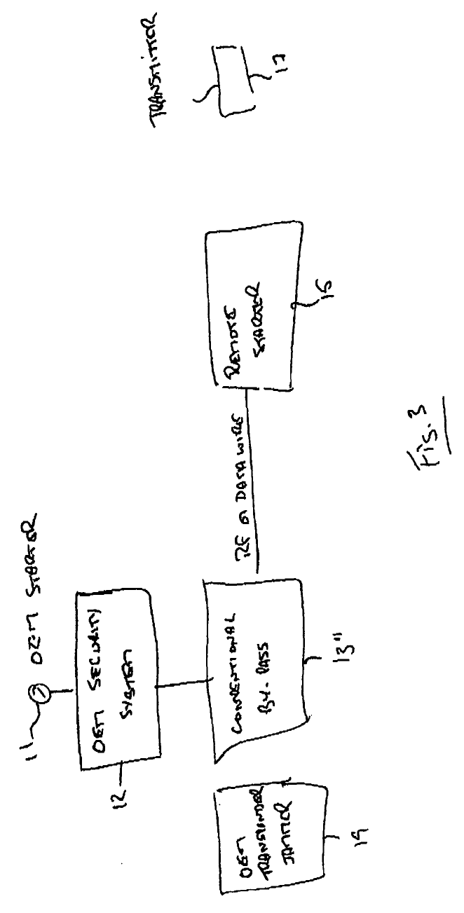

FIG. 2 is a schematic representation of the system according to a second preferred embodiment of the invention. In this case, the bypass is micro-processor based, and the vehicle is, as is standard, equipped with an OEM security system 12. This system is in communication with the bypass 13′, which does not have a transponder. The bypass is then in communication with the remote starter. Again, the information that is exchanged between the bypass and the remote starter is data, which helps prevent unauthorized bypass of the remote starter. Also, the communication could be unidirectional or bidirectional for added security.

As mentioned previously, the invention lies in the modification of the by-pass kit to adapt it to remotely start the vehicle only upon receipt of an authorized signal. Thus, applying a ground to the conventional microprocessor based by-pass or physically placing the transponder near the steering column will no longer permit thieves to steal the vehicle.

FIG. 3 is a schematic representation of yet another embodiment of the invention. There, an OEM transponder jammer 19 is provided, which continuously jams the OEM security system which is in listen mode, listening for a correct code to be received in order to start the car. In order to start the vehicle, the OEM transponder jammer must be disabled. To that effect, the transmitter 17 is adapted to send a signal to the OEM transponder jammer to disable it at the same time the remote starter is enabled. Thus, when the OEM transponder jammer is enabled, even having the right key in the ignition will not start the vehicle. It should be noted that this third embodiment can also be adapted to be used as an added security layer. In fact, for cars that are equipped with transponders, it is possible to have authorized persons, such as employees of a garage, program a second key into the vehicle, to enable these persons to start the vehicle. Thieves have been known to be in collusion with some garages, and use the newly programmed keys to steal the vehicle. Consequently, by having an OEM transponder jammer, the vehicle can only be started by the person having the transmitter to enable and disable the OEM transponder jammer.

In an advantageous embodiment, in the case where the vehicle is provided with an aftermarket security system, including a tracking device, the OEM transponder jammer can further be adapted to send a signal to an on-board chip which stores vital information such as the logical keys of the vehicle to erase them or burn the chip, thereby preventing further breaches of security.

In a preferred embodiment, the by-pass kit is adapted to “learn” the unique code associated with the remote starter, following technology which is readily available or communication between the remote starter and the by-pass kit can follow code-hopping techniques. In a further preferred embodiment, the code is encrypted following available techniques.

Although the present invention has been explained hereinabove by way of a preferred embodiment thereof, it should be pointed out that any modifications to this preferred embodiment within the scope of the appended claims is not deemed to alter or change the nature and scope of the present invention.

1. A system for preventing the unauthorized by-pass of an OEM security system, comprising:
an OEM starter for starting a vehicle;
an OEM security system in communication with said starter;
a by-pass kit for by-passing said OEM security system and enabling remote car starting of said vehicle without placing said key in said ignition;
a remote car starter device in communication with said by-pass kit for sending a signal to said by-pass kit to start said engine; and
a remote car starter transmitter in wireless communication with said remote car starter device;
wherein said signal is data that is sent to said by-pass kit is data, and wherein said by-pass kit is adapted to by-pass said OEM security system only upon receipt of said signal.

2. A system according to claim 1, wherein said remote car starter is in wireless communication with said by-pass kit.

3. A system according to claim 1, wherein said remote car starter is in communication with said by-pass kit through a cable.

4. A system according to claim 1, wherein said by-pass kit includes a transponder on board and is encased in metal.

5. A system for preventing the unauthorized by-pass of an OEM security system comprising:
an OEM starter;
an OEM security system in communication with said OEM starter, said OEM security system including a transponder for starting said engine upon receipt of an authorized signal;
a remote starter including a wireless transmitter, said remote starter being in communication with a conventional by-pass kit; and
an OEM transponder jammer for constantly jamming said transponder of said OEM security system when enabled,
wherein said transmitter is adapted to disable and enable said OEM transponder jammer, so that when said OEM transponder jammer is enabled, said vehicle cannot be started even with a correct signal being emitted to said OEM security system.
